(19) United States
(12) Patent Application Publication
(10) Pub. No.: US 2026/0072657 A1
(43) Pub. Date: Mar. 12, 2026

(54) INTELLIGENT CODE GENERATION

(71) Applicant: OPTUM, INC., Minnetonka, MN (US)

(72) Inventors: Venkat Kannappan, Mundelein, IL (US); Jatin Grover, Punjab (IN); Mohamed S Hamza, Naperville, IL (US); Monica Maryann Banaszak, Downers Grove, IL (US); Rahul Agrawal, Uttar Pradesh (IN); Narender Reddy Akula, Garnet Valley, PA (US)

(21) Appl. No.: 18/826,650

(22) Filed: Sep. 6, 2024

(51) Int. Cl. G06F 8/38; G06F 8/34; G06F 8/35; G06F 8/41

(52) U.S. Cl. CPC G06F 8/38; G06F 8/34; G06F 8/35; G06F 8/427

(57) ABSTRACT

Techniques for generating graphical user interface (GUI) code based on images of GUI components include obtaining an image depicting a GUI component and determining whether the component can be implemented by any existing GUI components stored in an asset database. When determining that the graphical user interface component can be implemented by at least one existing graphical user interface component, the techniques include retrieving from the asset database auxiliary data associated with the at least one existing graphical user interface component. When determining that the GUI component cannot be implemented by any existing GUI component, the techniques include (i) generating a new GUI component by generating an image associated with the GUI and auxiliary data, and (ii) storing the new GUI component in the asset database. The method further includes generating an abstract syntax tree on auxiliary data associated with the new graphical user interface components.

### FIELD

Generally, the present disclosure relates to algorithms for generating code for graphical user interfaces. More specifically, the techniques of this disclosure use machine learning to generate graphical user interface code from images representing graphical user interface components while reducing proliferation of redundant code.

### BACKGROUND

Generating graphical user interfaces (GUIs) can be a time-consuming process. Thus, applications that aim to automate the generation of GUI code are under development. These applications, however, often lead to proliferation of redundant code based on small changes in visual design. The proliferation of redundant code, in turn, reduces speed and efficiency of code repositories. Furthermore, code maintenance becomes a challenge. Potential lack of consistency in similar code modules can lead to code readability issues, errors, and/or lack of compliance in application GUIs.

### SUMMARY

In some aspects, a computer-implemented method comprises obtaining, by one or more processors, an image depicting a graphical user interface component. The computer-implemented method further comprises determining, by the one or more processors and using a machine learning model, whether the graphical user interface component depicted in the obtained image can be implemented by any existing graphical user interface component stored in an asset database. Still further, the computer-implemented method comprises, when determining that the graphical user interface component can be implemented by at least one existing graphical user interface component, retrieving from the asset database, by the one or more processors, auxiliary data associated with the at least one existing graphical user interface component. Still further, the computer-implemented method comprises, when determining that the graphical user interface component cannot be implemented by any of existing graphical user interface component, generating, by the one or more processors, a new graphical user interface component at least in part by generating an image associated with the new graphical user interface component and auxiliary data associated with the new graphical user interface component. Still further, the computer-implemented method comprises, when determining that the graphical user interface component cannot be implemented by any of the existing graphical user interface components, storing, by the one or more processors, the new graphical user interface component in the asset database. Still further, the computer-implemented method comprises generating, by the one or more processors, an abstract syntax tree based at least in part on either i) the auxiliary data associated with the at least one of existing graphical user interface component; or ii) the auxiliary data associated with the new graphical user interface component.

In some aspects, a system comprises memory and one or more processors communicatively coupled to the memory, the one or more processors configured to obtain an image depicting a graphical user interface component. The one or more processors are further configured to determine, by the one or more processors and using a machine learning model, whether the graphical user interface component depicted in the obtained image can be implemented by any existing graphical user interface component stored in an asset database. Still further, the one or more processors are further configured to retrieve from the asset database, when determining that the graphical user interface component can be implemented by at least one existing graphical user interface component, auxiliary data associated with the at least one of existing graphical user interface component. Still further, the one or more processors are configured to generate, when determining that the graphical user interface component cannot be implemented by any existing graphical user interface component, a new graphical user interface component at least in part by generating an image associated with the new graphical user interface component and auxiliary data associated with the new graphical user interface component. Still further, the one or more processors are configured to store, when determining that the graphical user interface component cannot be implemented by any of the existing graphical user interface components, the new graphical user interface component in the asset database. Still further, the one or more processors are configured to generate an abstract syntax tree based at least in part on either i) the auxiliary data associated with the at least one existing graphical user interface component; or ii) the auxiliary data associated with the new graphical user interface component.

### BRIEF DESCRIPTION OF THE DRAWINGS

The figures described below depict preferred embodiments for purposes of illustration only. One skilled in the art will readily recognize from the following discussion that alternative embodiments of the systems and methods illustrated herein may be employed without departing from the principles of the disclosure described herein.

FIG. 1 depicts an example computing environment in which various embodiments of the present disclosure may be implemented.

FIG. 2 depicts an example sequence for generating code from an image of a graphical user interface component.

FIG. 3 depicts an example breakdown of a graphical user interface component into constituent basic graphical user interface components.

FIG. 4 depicts an example representation of a graphical user interface with an existing graphical user interface component.

FIG. 5 depicts an example breakdown of a graphical user interface component into constituent basic graphical user interface components and an existing graphical user interface component.

FIG. 6 depicts an example training architecture for example machine learning models used for implementing the techniques of this disclosure.

FIG. 7 depicts a flow diagram representing an example computer-implemented method to implement the techniques of this disclosure.

### DETAILED DESCRIPTION

Broadly speaking, the techniques of the present disclosure relate to generating computer code for graphical user interfaces (GUIs). The developments in generative machine learning (ML) paved the way for generating computer code from a variety of prompts. For example, large language models (LLMs) enable generating computer code from text prompts. Additionally, machine learning models can be configured to generate annotations for images. It may be possible, therefore, to annotate an image of a GUI with text descriptions and use the text annotations as input to an LLM to generate code. Such an approach, however, requires substantial training of at least two machine learning models and may lead to an accumulation of errors from sequencing generative operations. The techniques of this disclosure, on the other hand, relate to generating computer code directly from images of GUI components. Furthermore, the techniques of this disclosure can identify certain images of GUI components as representations of existing GUI components, obviating the need for generating all components from scratch.

Rather than generating computer code directly, the techniques of this disclosure may generate abstract syntax trees (ASTs) to represent GUI components. Representing GUI components as ASTs carries the advantage of flexibility in generating the final code to represent GUIs, as a variety of compilers or additional generative models may be used to generate code from ASTs in a suitable language and/or a platform of choice.

Direct image-to-code generation poses certain challenges. For example, small differences in visual designs may result in the proliferation of code modules associated with GUI components having similar functionalities. Resulting code libraries may become difficult to maintain and associated designs may have undesirable style variability. Furthermore, generating new designs based on existing code libraries with redundant components may become slow and unreliable, with small changes in inputs leading to undesirable differences in implementations.

The techniques of this disclosure include a computing system using a combination of ML models working cooperatively to generate code for GUI components represented by input images. Furthermore, the computing system may determine a hierarchical structure of a GUI design. The computing system may be configured to identify one or more portions of an image of a GUI as representations of GUI components. Additionally or alternatively, the computing system may obtain GUI component images by receiving the images from external devices. The computing system is configured to identify or determine whether the GUI components can be implemented using existing GUI components stored in an asset database and retrieve the respective GUI components from an asset database. The computing system is further configured to generate new GUI component assets when respective representations of GUI components do not have suitable implementations within the asset database. In some examples, the computing system is further configured to combine implementations of newly generated and retrieved components into a GUI design encoded in a logical structure, such as an AST. Additionally or alternatively, the computing system may implement the encoded design in a suitable language.

The techniques of the present disclosure have technical advantages over conventional techniques and techniques under development. The techniques of this disclosure address a number of challenges in direct image-to-code generation by combining a classification ML model with a generative ML model. The classification ML model is configured to determine whether a GUI component represented by an input image can be implemented by an existing GUI component stored in an asset database. When the GUI component represented by the input image cannot be implemented by an existing GUI component, the generative ML model can implement the GUI component as a new GUI component. The new GUI component is then stored in the asset database. The GUI components may be encoded as ASTs, for example.

By both reusing existing GUI components and generating new ones, the techniques of this disclosure improve speed and robustness of GUI construction, as well as ensuring style uniformity across applications. These advantages stem from reducing proliferation of generated GUI components. Limiting the number of GUI components by reusing existing GUI components also improves performance (e.g., speed of access, memory requirements, energy efficiency, etc.) of the asset database. Agility and robustness of the overall code generating system are improved by maintaining a manageable number of GUI component assets, with the GUI component assets sufficiently distinct from each other to avoid inadvertent substitutions.

The techniques of this disclosure can allow a trade-off between compliance and “creativity” of the code generating system. For example, the classification ML model may generate a set of similarity metrics for each existing GUI component with respect to the GUI component represented by the input image. The similarity metrics may be indicative of the likelihood (or a set of likelihood metrics) that the GUI component represented by the input image can be suitably implemented as the respective existing GUI component. In a sense, a similarity metric can be thought of as an indication of a quality of match with a respective existing GUI component. A candidate existing GUI component may be chosen as the existing component with the highest or maximum similarity metric. In some embodiments, the system compares the maximum similarity metric to a threshold to determine whether the candidate GUI component can implement the GUI component under consideration. A flexible threshold (for a minimum similarity required to implement the GUI component represented by the input image with an existent GUI component) can determine how creative the code generation system is allowed to be.

Of course, it should be appreciated that the advantages and technical improvements described above and elsewhere herein are not the only advantages and/or technical improvements that may be realized using the techniques described herein. Other advantages and/or technical improvements to the functioning of a computer itself or other technologies or technical fields will be apparent to one of ordinary skill in the art. Moreover, while described herein primarily in the health care claims context, the techniques described herein may be readily applied in any suitable field for any suitable purpose.

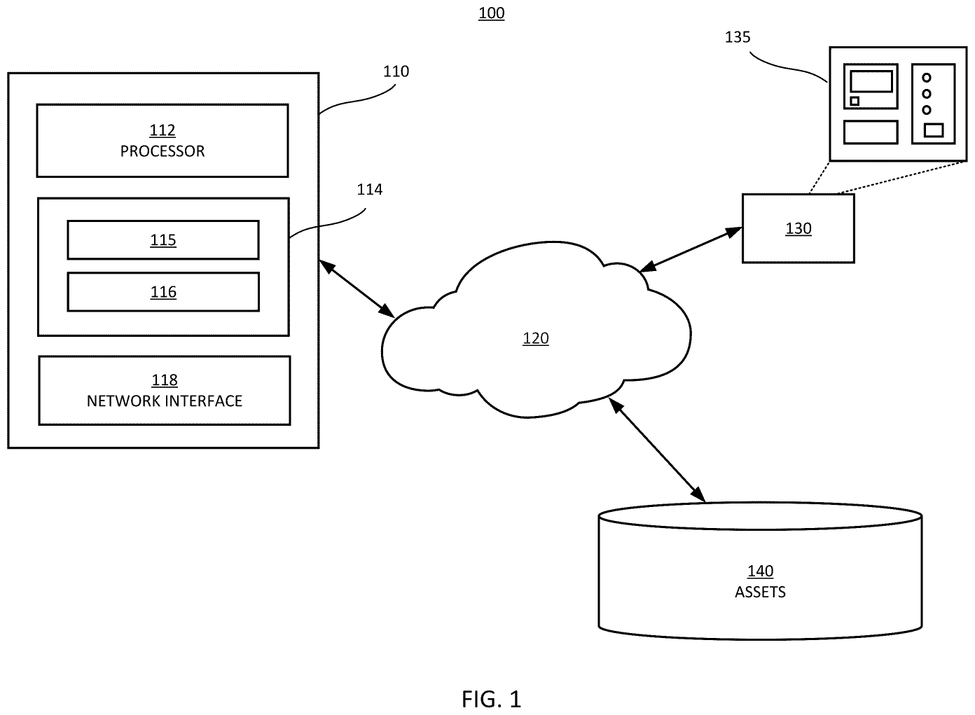

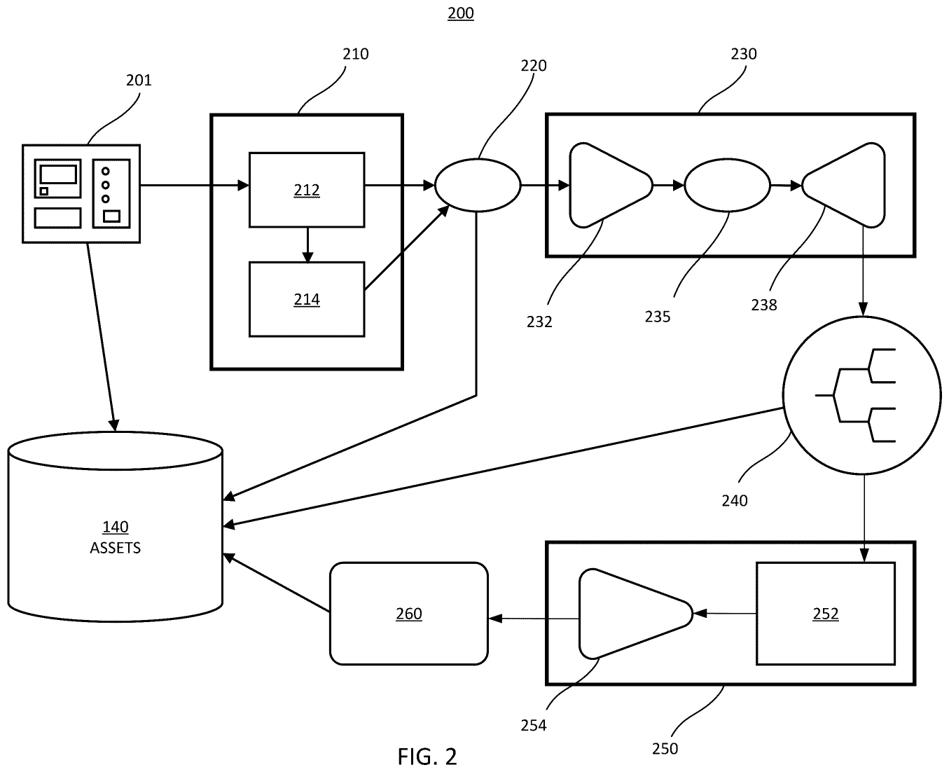

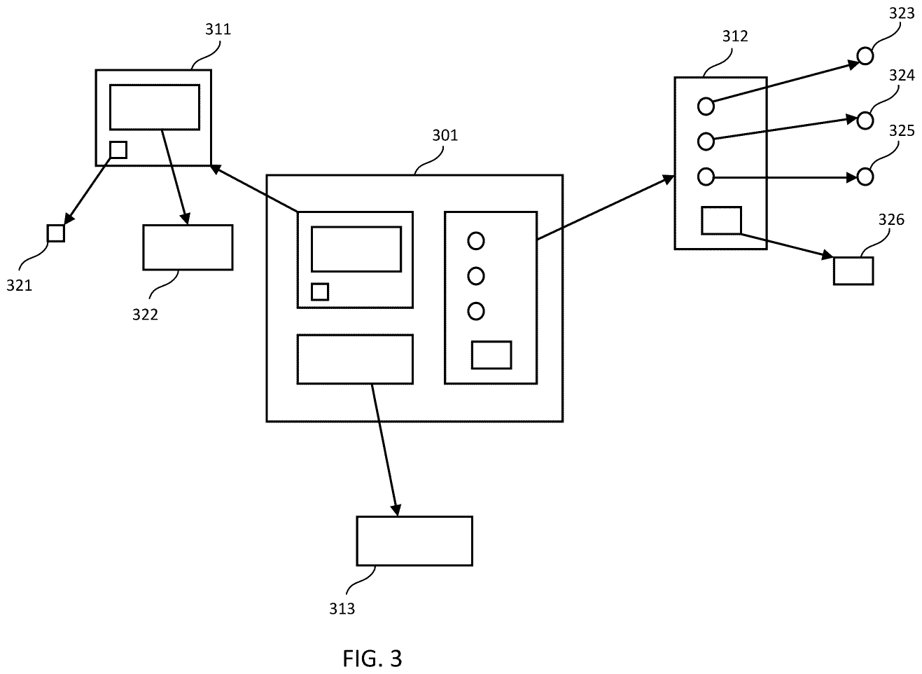

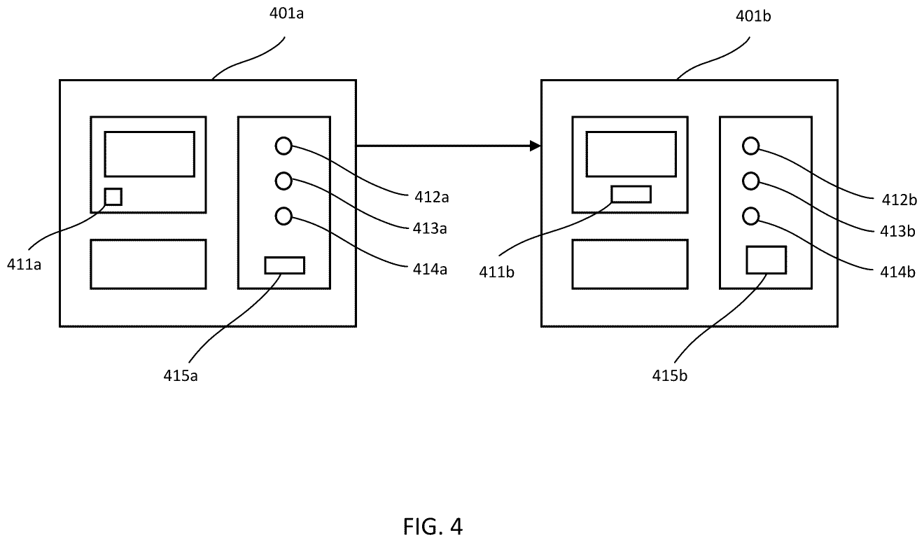

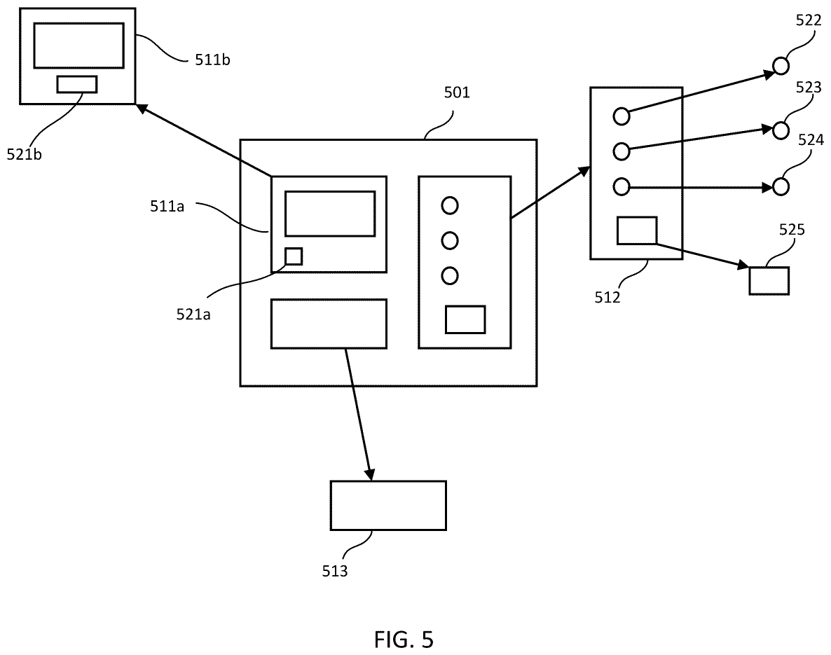

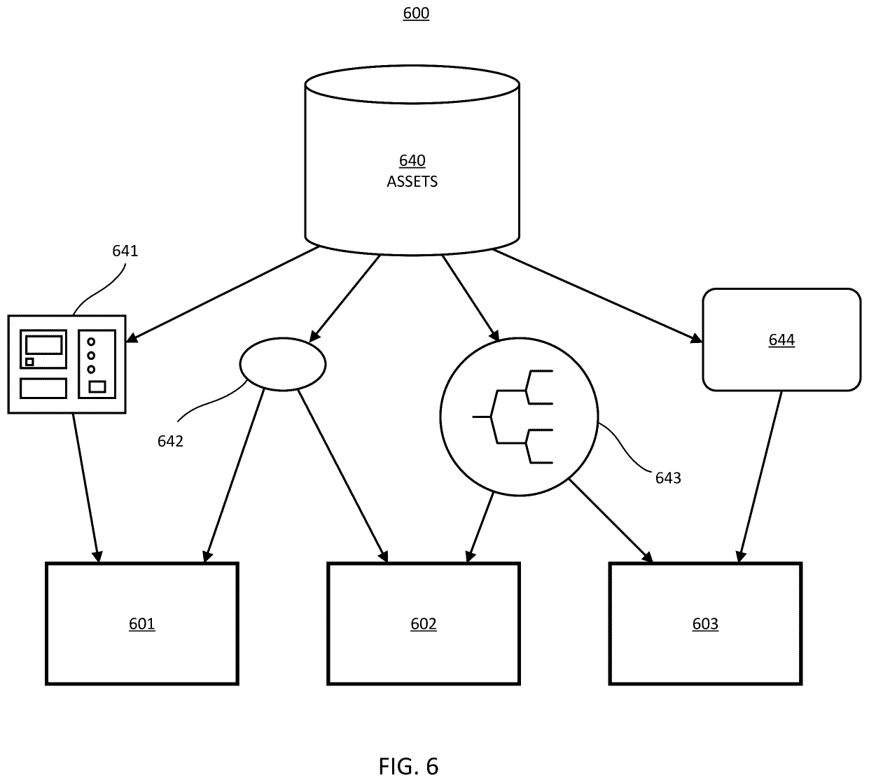

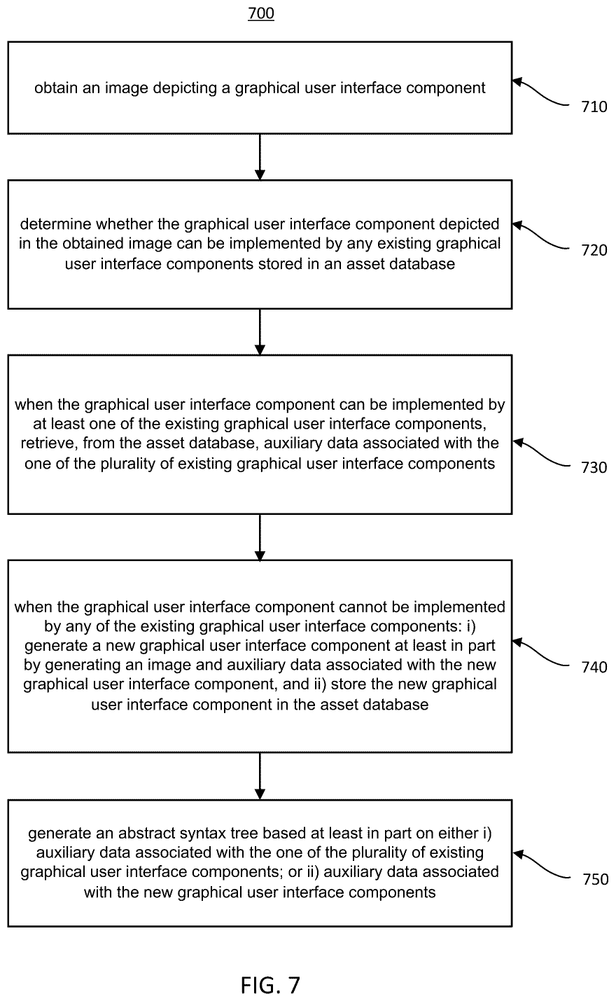

To provide a better understanding of the techniques described herein, FIG. 1 depicts an example computing environment in which various embodiments of the present disclosure may be implemented. FIG. 2 depicts an example sequence for generating code from an image of a GUI component. The sequence of FIG. 2 may be implemented within the computing environment of FIG. 1. FIG. 3 depicts an example breakdown of a GUI component into constituent basic GUI components. FIG. 4 depicts an example implementation of a GUI component represented by the input image with an existing GUI component. FIG. 5 depicts an example breakdown of a GUI component into constituent basic GUI components and an existing GUI component. The breakdowns and implementations of FIGS. 3-5 may be implemented within the sequence of FIG. 2. FIG. 6 depicts an example training architecture for example ML models used for implementing the techniques of this disclosure, such as the techniques discussed with reference to FIG. 2. FIG. 7 depicts a flow diagram representing an example computer-implemented method, in accordance with various embodiments described herein. The method of FIG. 7 may be implemented within the context of the computing environment of FIG. 1.

FIG. 1 depicts an example computing environment 100 in which techniques of the present disclosure may be implemented. The computing environment 100 includes a computing system 110 configured for implementing the techniques of this disclosure. The computing system 110 includes a processor 112 communicatively coupled to memory 114 which may store ML models 115 and 116, and communicatively coupled to a network interface 118. The computing system 110 is coupled, by way of the network interface 118, to a network 120.

The computing environment 100 additionally includes an example device 130 (e.g., a computer workstation, a digital camera, a mobile computing device, etc.) communicatively coupled to the network 120. The example device 130 is configured to generate or capture an image 135 of a GUI component for processing by the computing system 110. To that end, the device 130 is communicatively connected to the network 120 from which the computing system 110 can receive the GUI component image 135. In some examples, the image 135 may depict representations of multiple GUI components. The computing system 110 may be configured for segmenting images of individual GUI components from the image 135.

The computing environment 100 includes an asset database 140 communicatively connected to the network 120. Additionally or alternatively, at least a portion of the asset database 140 may be implemented within the memory of the computing system 110. The asset database 140 may store existing GUI components. The computing system 110 is configured to use the existing GUI components stored in the asset database 140 to generate ASTs and/or computer code for a GUI component or a plurality of GUI components represented within the image 135. Furthermore, the assets stored in the asset database 140 may comprise a dataset used for training ML models (e.g., ML models 115 and 116) used by the computing system 110. In some examples, the training of the ML models 115 and 116 is performed, at least in part, by the computing system 110. In other examples, the ML models 115 and 116 are trained by a computing system distinct from the computing system 110.

FIG. 2 depicts an example sequence 200 for generating code from an image of a GUI component, which may be implemented by a system (e.g., computing system 110) comprising memory (e.g., memory 114) and one or more processors (e.g., processor 112) communicatively coupled to the memory. The sequence 200 includes stages 210, 230 and 250 implemented using a variety of algorithms and/or ML models (e.g., ML models 115 and 116).

Image analysis stage 210 of the sequence 200 includes obtaining an image 201 (e.g., image 135) depicting a GUI component. The image 201 may be generated on a workstation using design software (e.g., Figma) or captured using a digital imaging device. In some examples, the image 201 may be a digitized hand drawing. In some examples, the image 201 is an image segmented from a previous image input. That is, at least a portion of the sequence 200 may operate recursively. Therefore, the system may obtain images (e.g., image 201) by receiving images from an external source and/or internally generating images by segmenting larger images previously received and/or previously segmented.

The image analysis stage 210 further includes determining whether the GUI component depicted in the obtained image 201 can be implemented by any existing GUI components stored in an asset database (e.g., asset database 140). The components stored in the asset database may include basic GUI components, such as boxes, images, text labels, text fields, paragraphs, buttons, check-boxes, radio buttons, drop-down lists, indicators, graphs, etc. The components stored in the asset database may include complex components built by combining basic components. The computing system 110, for example, may add complex components processed by the sequence to the asset database.

To determine whether the GUI component depicted in the obtained image 201 can be implemented by any existing GUI components stored in an asset database, the example image analysis stage 210 includes an ML model (e.g., ML model 115) configured to classify the obtained image 201. The ML model may be a convolutional neural network (CNN) that includes classification layers 212, for example. The classification layers 212 of the ML model may be trained on images associated with GUI components stored in the asset database, as discussed in more detail with reference to FIG. 4. The classification layers 212 may classify an input image 201 by generating a metric for at least a portion of the GUI components stored in the asset database. The generated metrics may be indicative of respective likelihoods with a given existing GUI component can implement the GUI component represented in the obtained image 201. The image analysis stage 210 may select one or more existing GUI components with the highest metrics as candidate GUI components. The image analysis stage 210 may compare the metrics to a threshold and, if none of the metrics exceed the threshold, reject the candidate GUI components and classify the GUI component represented by the obtained image 201 as a new GUI component. In some embodiments, the threshold may be set to change creativity of the system. A high threshold may lead to higher creativity by necessitating that the GUI component represented by the obtained image 201 closely resembles at least one of the existing GUI components. On the other hand, a low threshold may lead to an increased level of compliance by implementing the GUI component represented by the obtained image 201 with a more loosely matched existing GUI component. In some examples, the threshold can be set by an operator of the system. In other examples, the threshold may change automatically. For example, the threshold may change in favor of compliance as the number of existing GUI components in the asset database increases.

When the GUI component can be implemented by at least one of the existing GUI components (e.g., as determined by the classification layers 212), the image analysis stage 210 may retrieve their respective existing GUI components from the asset database. In some examples, the image analysis stage 210 may select the best matching existing GUI component. In other examples, the image analysis stage 210 prompts an operator to select from among several of the best matching existing GUI components. In any case, retrieving existing GUI components from the asset database includes retrieving auxiliary data associated with the respective existing GUI components. The auxiliary data may include data indicative of basic GUI components disposed within the retrieved GUI components and their respective geometric positions. In some examples, the auxiliary data includes, for each retrieved existing GUI component, a respective AST and/or a respective computer code segment. The retrieved existing GUI component to implement the GUI component represented by the obtained image 201 may be a basic component.

The image analysis stage 210 may determine that the GUI component represented by the obtained image 201 cannot be implemented by any of the existing GUI components. In that case, the sequence 200 may generate a new GUI component. To generate the new GUI component, the sequence 200 may generate an image associated with the new GUI component and auxiliary data associated with the new GUI component. The sequence 200 may store the new GUI component in the asset database.

The image analysis stage 210 may generate the image associated with the new GUI component from the obtained image 201. In some examples, the obtained image 201 becomes the image associated with the new GUI component. In other examples, the image analysis stage 210 may perform suitable transformations on the obtained image 201. The transformations may include cropping, scaling of the whole image and/or sections of the image, and/or other adjustments (e.g., style transfer operations). The image analysis stage 210 may generate at least some of the auxiliary data associated with the new GUI component.

The image analysis stage 210 may generate a feature vector associated with the new GUI component. To that end, the ML model used in the image analysis stage 210 may include feature generating layers 214. The generated feature vector may be indicative of basic GUI components (and their respective pixel locations or coordinates) comprising the new GUI component. In some examples, the generated feature vector is indicative of existing complex GUI components (and their pixel locations or coordinates) comprising the new GUI component. In any case, the feature generating layers 214 are configured to detect and label GUI components comprising the new GUI component. The constituent GUI components may be referred to as GUI objects, and the feature generating layers 214 may be referred to as object detection layers. The generated feature vector may be included in the auxiliary data associated with the new GUI component.

The image analysis stage 210 may generate an output feature vector 220. The output feature vector 220 may be a feature vector retrieved from the asset database or a feature vector generated by the feature generating layers of an ML model of the image analysis stage 210. When the output feature vector 220 is generated by the feature generating layers, the sequence 200 may include storing (e.g., by the image analysis stage 210) the output feature vector 220 in the asset database as part of auxiliary data associated with a new GUI component. The output feature vector 220 indicative of the pixel positioning and the classification of nested GUI components within the new GUI component is then passed to an AST generating stage 230.

Whether generated by the image analysis stage 210 or retrieved by the image analysis stage 210 from the asset database, the output feature vector 220 may serve as input for the AST generating stage 230. The AST generating stage 230 is configured to generate an AST for the GUI component represented by the input image 201. When the image analysis stage 210 determines that the GUI component represented by the input image 201 can be implemented by an existing GUI component, the AST generating stage 230 may either retrieve the AST from the asset database or generate the AST using a generative ML model. The generative ML model may be a transformer model.

The generative ML model of the AST generating stage 230 includes an encoder 232 configured to receive the output feature vector 220 generated by the image analysis stage 210 and generate an encoded feature vector 235. The encoded feature vector 235 may serve as input to a decoder 238. The decoder 238 is configured to generate an AST 240 based on encoded feature vectors 235. To that end, the decoder 238 may work cooperatively with an attention layer. In some examples, the AST generating stage 230 may not need the decoder 238. That is, the decoder 238 may be integrated into a subsequent stage of the sequence 200. The encoder 232 and decoder 238 of the AST generating stage 230 may be trained on the existing GUI data stored in the asset database. The data stored in the asset database may be enhanced for training discussed in more detail with reference to FIG. 4.

The AST 240 serves as input into a code-generating stage 250 of the sequence 200. To that end, the AST 240 may be presented in JavaScript Object Notation (JSON) or another suitable representation (e.g., as vectors). The code generating stage 250 includes an attention layer 252 and a decoder 254. In some examples, the AST generating stage 230 and the code generation stage 250 may use a combined ML transformer model with the 240 AST as an intermediate encoding. Using the AST 240 as the encoding prior to generating computer code and leveraging the AST 240 in the attention layer 252 improves the accuracy of code generation. The code generation stage 250 uses the attention layer 252 to selectively focus on the relevant parts of the AST 240 and to provide GUI component context based on prior training. For example, the attention layer 252 provides, based on context, the closest associated section of the AST 240 for generating code. The attention layer 252 then generates output embeddings and/or tokens to the decoder 254. The decoder 254 of the code generation stage 250 then converts the output embeddings and/or tokens into a computer code 260 segment associated with the GUI component represented by the input image 201.

The sequence 200 includes saving, for a new GUI component, data associated with the new GUI component indicative of inputs and outputs of each of the stages 210, 230 and 250. The example sequence 200 saves data indicative of the input image 201, the generated output feature vector 220, the AST 240 and the code 260. Another example sequence may save only a portion of the data associated with the new GUI component. For example, the sequence may save image data and feature vector data. Additionally or alternatively, the sequence may save AST, but not the final code. Thus, the asset database may include heterogeneous data for the existing GUI components. In any case, the data saved for each existing GUI component may be sufficient to generate a code segment for the respective component with a suitable sequence.

FIG. 3 depicts an example breakdown of a GUI component 301 into constituent basic GUI components 311-313 and 321-326. The GUI component 301 may be represented by the input image 201 of FIG. 2. The GUI component 301 may be identified by a system (e.g., by the computing system 110, the stage 210) as a new GUI component. The system (e.g., using the feature generating layers 214) may generate a feature vector indicative of constituent GUI components 311-313 and 321-326 of the new GUI component 30 and the associated pixel locations. The system may breakdown the new GUI component 301 in a hierarchical manner. For example the basic GUI component 311 may be a box or a container containing the basic GUI components 321, which may be a button, and the basic GUI component 322, which may be a paragraph field. The basic GUI component 312 may be a box or a container containing the basic GUI components 323, 324, 325, which may be radio buttons and the basic GUI component 326, which may be a button. The basic component GUI component 313 may be another paragraph field or an image field. The breakdown of the GUI component 301 may be hierarchical with the components 311-313 on a level immediately below the GUI component 301, and the GUI components 321-326 on a subsequent level of the hierarchy.

FIG. 4 depicts an example implementation of a GUI component 401a (which may be represented by the input image 201) with an existing complex GUI component 401b. For example, the image analysis stage 210 may determine that the GUI component 401a is sufficiently similar to and may be implemented by the GUI component 401b. Constituent basic GUI components 411a, 412a, 413a, 414a, and 415a, of the GUI component 401a may be replaced within the GUI component 401b by basic GUI components 411b, 412b, 413b, 414b, and 415b, respectively. The basic GUI components 411a and 415b may be buttons that can be equivalently implemented by the basic GUI components 411b and 415b, also buttons. The basic GUI components 412a, 413a, and 414a may be radio buttons that can be implemented by the identical basic GUI components 412b, 413b, and 414b, albeit at different pixel positions within the GUI component 401b than in the GUI component 401a. Implementing the GUI component 401a with the existing complex GUI component 401b may prevent proliferation of similar GUI components. On the other hand, a threshold for a metric of similarity may be set to allow the creation of the new complex GUI component 401a and storing the new GUI component 401a in the asset database.

FIG. 5 depicts an example breakdown of a GUI component 501 (which may be represented by the input image 201) into constituent basic GUI components 512, 513 and 522-525 and an existing complex GUI component 511b. To that end, a system (e.g., computing system 110, possibly implementing the sequence 200) may segment within the image of the GUI component 501, an image representing a complex GUI component 511a. The system may in turn identify the complex GUI component 511a as capable of being implemented by the existing complex GUI component 511b. A simple GUI component 521a within the complex GUI component 511a may be replaced within the complex GUI component 511b by the simple GUI component 521b. Replacing a portion of the GUI component 501 by an existing component prevents proliferation of code and maintains efficiency of an asset database storing existing GUI components. More generally, a system may identify (e.g., segment) various elements of a GUI design and classify them as simple elements (e.g., HTML elements), elemental components (e.g., React), or more complex components that are combinations of elemental components (e.g., MUI template-based). Simple elements and elemental components may be considered basic GUI components. Newly generated complex GUI components may be added to the asset database to supplement previously available libraries of complex GUI components.

FIG. 6 depicts an example training architecture 600 for example ML models 601-603 which may be used to implement the techniques of this disclosure. The example ML model 601 may be implemented within the image analysis stage 210 of the sequence 200. The ML model 601 may include classification layers (e.g., classification layers 212) and in the feature generating layers (e.g., feature generating layers 214). In some examples, the ML model 601 may include image segmentation layers. The ML model 601 may be trained using image data 641 and feature vector data 642 stored as parts of a dataset in an asset database 640 (which may be the asset database 140). For the purpose of training, the training image data 641 may be augmented with a variety of image transformations to expand a set of training input images. For example, for a given existing GUI component, the training architecture 600 may include generating images to be classified as the given existing GUI component as well as images that should not be classified as the given existing GUI component. In this manner, the training can include false positives in addition to false negatives for training classification layers of the ML model 601. The ML model 601 may be trained to generate feature vectors (e.g., using feature vector generation layers). To that end, the ML model 601 may be trained with feature vectors corresponding to the images in the training image data 641. In some examples, feature vector data 642 may include a feature vector for every image in the training image data 641. That is, images generating by augmentation of the stored images in the asset database 640 may each have a corresponding feature vector. In other examples, multiple images from an augmented image data set may correspond to the same output feature vector in the training set.

The example ML model 602 may be implemented within the AST generating stage 230 of the sequence 200. The ML model 602 may be trained to generate ASTs based on feature vectors. To that end, the training data set may be based on the feature vector data 642 in the asset database 640 and the respective AST data 643 stored in the asset database. In some examples, each feature vector may have a unique respective AST in the training data set. In other examples, multiple feature vectors may be represented by the same AST.

The example ML model 603 may be implemented within the code generation stage 250 of the sequence 200. The ML model 603 may be trained to generate code based on input ASTs. To that end, the training data set may be based on the AST data 643 stored in the asset database 640 and code data 644 stored in the asset database 640. In some examples, at least some of the code data for training may be generated based on AST data using suitable compilers. Furthermore, the ML model 603 code generation may have an input indicative of platform, language, or any other suitable variable altering a desirable code implementation for a given AST. Therefore, a single AST in a training data set for the ML model 603 may have multiple outputs code segments that depend on suitable input variables of the ML model 603.

As the number of assets in an asset database grows, so do the capabilities of the ML models 601-603. The ML models 601-603 may be trained by the computing system 110 or another suitable computing system. The ML models may be re-trained on a schedule, based on the increase in GUI components stored in the asset database, or any other suitable triggers.

FIG. 7 depicts a flow diagram representing an example computer-implemented method 700 to implement the techniques of this disclosure. The method 700 is implemented by one or more processors, e.g., processor 112 of the computing system 110. The method 700 includes blocks 710-750.

At block 710, the method 700 includes obtaining an image (e.g., image 135, 201) depicting a GUI component (e.g., GUI component 301, 401a, or 501). Obtaining the image may include receiving the image from an external device (e.g., device 130). For example, the image may be an output of design software, such as Figma, Canva, Visio, etc. Alternatively, the image may be a digitized image of a hand drawing. In some examples, the image may be segmented from a larger image of a GUI. A portion of the method 700 may operate recursively, generating, from an original GUI, component images that are obtained at block 710.

At block 720, the method 700 includes determining whether the GUI component depicted in or represented by the obtained image can be implemented by any existing GUI component (e.g., 401b, 511b) stored in an asset database (e.g., asset database 140, 640). To that end, the method 700 may employ an MI model (e.g., a CNN) having classification layers (e.g., classification layers 212). The classification layers may generate, e.g., for each of a selected plurality of GUI components stored in an asset database, a metric. The selected plurality of GUI components may include all the GUI components stored in the asset database. This stored GUI components may include simple elements (e.g., HTML elements), elemental components (e.g., React), or more complex components that are combinations of elemental components (e.g., MUI template-based). The metrics may be indicative of respective likelihoods that the GUI component represented by the obtained image can be implemented by each GUI component within the selected plurality of GUI components. The largest metric may indicate a class of GUI components to which the GUI component represented by the input image is assigned. When the largest metric is below a threshold, the GUI component may be assigned to a “new GUI component” class. That is, the GUI component represented by the input image may be determined to be a new GUI component.

At block 730, the method 700 includes, when determining that the GUI component can be implemented by at least one existing GUI component, retrieving, from the asset database, auxiliary data associated with the at least one existing GUI component. The auxiliary data for the at least one existing GUI component may be an instantiation of the class of the existing GUI component with a number of attributes. The auxiliary data may include a feature vector for the at least one existent component, where the feature vector may later serve as an input to an ML model generating an AST for the at least one existing GUI component. In other examples, the auxiliary data may include the AST for the at least one existing GUI component.

At block 740, the method 700 includes, when determining that the GUI component cannot be implemented by any existing GUI component: i) generating a new GUI component and ii) storing the new GUI component in the asset database. The new GUI component is generated at least in part by generating an image associated with the new GUI component and auxiliary data associated with the new GUI component. The auxiliary data may include a feature vector. To generate the feature vector, the method 700 may use feature generating layers of an ML model at block 740. The generated feature vector may be indicative of constituent GUI components of the new GUI component and their respective pixel positions within the new GUI component. To determine the constituent GUI components of the new GUI component, the method 700 may include using segmentation layers (e.g., within the feature generating layers) and for a feedback path to block 720. The ML model used at block 740 may be trained as discussed with reference to FIG. 3.

At block 750, the method 700 includes generating an AST based at least in part on either i) auxiliary data associated with the at least one existing GUI component; or ii) auxiliary data associated with the new GUI component. The auxiliary data may include feature vectors as described above. To generate ASTs based on the feature vectors, the method may use at block 750, a generative ML model (e.g., as at least in part implemented within stage 230). The generative ML model may encode (e.g., using encoder 232) the feature vectors into encoded feature vectors (e.g., encoded feature vector 235) that can be decoded by a decoder (e.g., decoder 238). The generative ML model used at block 750 may be trained as discussed with reference to FIG. 3.

The method 700 may further include leveraging the generated AST in an attention layer (e.g., attention layer 252) to transform the AST into code. The attention layer may combine the AST with contextual information to encode a feature vector for a decoder (e.g., decoder 254). In turn, the decoder may generate a computer code segment for the GUI component represented by the input image. In some examples, the decoder in combination with the attention layer may generate embeddings and/or token from which the computer code may be generated.

### ADDITIONAL CONSIDERATIONS

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The systems and methods described herein are directed to an improvement to computer functionality, and improve the functioning of conventional computers. Additionally, certain embodiments are described herein as including logic or a number of routines, subroutines, applications, or instructions. These may constitute either software (e.g., code embodied on a non-transitory, machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules include a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also may include the plural unless it is obvious that it is meant otherwise.

Upon reading this disclosure, those of skill in the art will appreciate still additional alternative structural and functional designs through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112(f) unless traditional means-plus-function language is expressly recited, such as “means for” or “step for” language being explicitly recited in the claim(s).

1. A computer-implemented method comprising:
obtaining, by one or more processors, an image depicting a graphical user interface component;
determining, by the one or more processors and using a machine learning model, whether the graphical user interface component depicted in the obtained image can be implemented by any existing graphical user interface component stored in an asset database;
when determining that the graphical user interface component can be implemented by at least one existing graphical user interface component, retrieving from the asset database, by the one or more processors, auxiliary data associated with the at least one existing graphical user interface component;
when determining that the graphical user interface component cannot be implemented by any existing graphical user interface component:
generating, by the one or more processors, a new graphical user interface component at least in part by generating an image associated with the new graphical user interface component and auxiliary data associated with the new graphical user interface component; and
storing, by the one or more processors, the new graphical user interface component in the asset database; and
generating, by the one or more processors, an abstract syntax tree based at least in part on either i) the auxiliary data associated with the at least one existing graphical user interface component; or ii) the auxiliary data associated with the new graphical user interface component.

2. The computer-implemented method of claim 1, further comprising:
generating, by the one or more processors, and based on the abstract syntax tree, a code segment associated with the image depicting the graphical user interface component; and
storing, by the one or more processors, the generated code segment in the asset database.

3. The computer-implemented method of claim 2, wherein generating the code segment based on the abstract syntax tree includes using an attention layer trained based on training data stored in the asset database.

4. The computer-implemented method of claim 1, wherein the machine learning model is a convolutional neural network including classification layers and feature generating layers.

5. The computer-implemented method of claim 4, wherein:
the classification layers are configured to classify the graphical user interface component as (i) one of a plurality of existing complex graphical user interface components stored in the asset database or (ii) one of a plurality of basic graphical user interface components.

6. The computer-implemented method of claim 4, wherein:
the feature generating layers are configured to generate the auxiliary data associated with the new graphical user interface component, and
the auxiliary data associated with the new graphical user interface component is indicative of a plurality of constituent graphical user interface components.

7. The computer-implemented method of claim 6, wherein each of the plurality of constituent graphical user interface components is one of a plurality of basic graphical user interface components.

8. The computer-implemented method of claim 6, wherein at least one of the plurality of constituent graphical user interface components is one of a plurality of existing complex graphical user interface components stored in the asset database.

9. The computer-implemented method of claim 1, wherein obtaining, by the one or more processors, the image depicting the graphical user interface component, includes identifying the image depicting the graphical user interface component within a larger image depicting a plurality of graphical user interface components.

10. The computer-implemented method of claim 1, wherein determining whether the graphical user interface component depicted in the obtained image can be implemented by any of the existing graphical user interface components includes:
computing a plurality of metrics each indicative of a quality of match associated with a respective one of a plurality of existing complex graphical user interface components,
selecting a maximum metric from the plurality of metrics, and
comparing the maximum metric to a threshold.

11. The computer-implemented method of claim 1, wherein the machine learning model is trained using a dataset stored in the asset database.

12. The computer-implemented method of claim 11, wherein the dataset includes the image depicting the graphical user interface component.

13. A system comprising memory and one or more processors communicatively coupled to the memory, wherein the one or more processors are configured to:
obtain an image depicting a graphical user interface component;
determine, using a machine learning model, whether the graphical user interface component depicted in the obtained image can be implemented by any existing graphical user interface components stored in an asset database;
when the graphical user interface component can be implemented by at least one of the existing graphical user interface components, retrieve, from the asset database, auxiliary data associated with the at least one of the existing graphical user interface components;
when the graphical user interface component cannot be implemented by any of the existing graphical user interface components:
generate a new graphical user interface component at least in part by generating an image associated with the new graphical user interface component and auxiliary data associated with the new graphical user interface component; and
store the new graphical user interface component in the asset database; and
generate an abstract syntax tree based at least in part on either i) auxiliary data associated with the at least one of the existing graphical user interface components; or ii) auxiliary data associated with the new graphical user interface components.

14. The system of claim 13, wherein the one or more processors are further configured to:
generating, by the one or more processors, and based on the abstract syntax tree, a code segment associated with the image depicting the graphical user interface component; and
storing, by the one or more processors, the generated coded segment in the asset database.

15. The system of claim 14, wherein generating the code segment based on the abstract syntax tree includes using an attention layer trained based on training data stored in the asset database.

16. The system of claim 13, wherein the machine learning model is a convolutional neural network including classification layers and feature generating layers.

17. The system of claim 16, wherein:
the classification layers are configured to classify the graphical user interface component as one of existing complex graphical user interface components stored in the asset database or one of a plurality of basic graphical user interface components.

18. The system of claim 16, wherein:
the feature generating layers are configured to generate the auxiliary data associated with the new graphical user interface component, and
the auxiliary data associated with the new graphical user interface component is indicative of a plurality of constituent graphical user interface components.

19. The system of claim 18, wherein each of the plurality of constituent graphical user interface components is one of a plurality of basic graphical user interface components.

20. The system of claim 18, wherein at least one of the plurality of constituent graphical user interface components is one of a plurality of existing complex graphical user interface components stored in the asset database.

21. The system of claim 13, wherein obtaining, by the one or more processors, the image depicting the graphical user interface component, includes identifying the image depicting the graphical user interface component within a larger image depicting a plurality of graphical user interface components.

22. The system of claim 13, wherein determining whether the graphical user interface component depicted in the obtained image can be implemented by any of the existing graphical user interface components, includes:
computing a plurality of metrics, wherein each one of the plurality of metrics is indicative of a quality of match associated with a respective one of a plurality of existing complex graphical user interface components,
selecting a maximum metrics from the plurality of metrics, and
comparing the maximum metric to a threshold.

23. The system of claim 13, wherein the machine learning model is trained using a dataset stored in the asset database.

24. The system of claim 23, wherein the dataset includes the image depicting the graphical user interface component.
